(19) United States
(12) Patent Application Publication
(10) Pub. No.: US 2005/0168067 A1
(43) Pub. Date: Aug. 4, 2005

(54) Dynamic adaptive damping attenuant mechanism and energy recycling system on braking

(76) Inventors: Yen-Weay Hsu, Taipei (TW); Tsun-Cheng Lin, Taipei Hsien (TW); Jiunn-Huei Chen, Nan-Tou Hsien (TW); Ying-Yin Ting, Taipei (TW)

Correspondence Address: HERSHKOVITZ & ASSOCIATES, 1725 I STREET NW, SUITE 300, WASHINGTON, DC, 20006, US

(21) Appl. No.: 10/765,869

(22) Filed: Jan. 29, 2004

(51) Int. Cl. B60T 8/64

(52) U.S. Cl. 303/152

(57) ABSTRACT

The “Dynamic-Adaptive-Damping-Attenuant Mechanism”, which is called DADAM, is as the bridge of the mechanical-electrical interconnected system. Not only the DADAM is as the dynamic buffer zone and the size is regulated adaptively and proportional to the load, but also provides the self attenuation area with attenuating the superabundant energy. This is the key why the superabundant braking energy could be recycled. Such as the system could be stable and more reliable, even the over limited load, as the shock of high voltage, occurred. For appling to the vehicle braking system, the distance of braking is shortened.

### BACKGROUND OF THE INVENTION

1. Field of the Invention

The present invention relates to a dynamic adaptive damping attenuant mechanism and energy recycling system on braking.

2. Description of Related Art

In this work, we are focused on discovering the interconnected mechanism between the mechanical and electrical systems to make sure that the system is stable and more reliable, even the limiting load occurred. Therefore, it is called “Dynamic-adaptive damping attenuate mechanism”, in short, DADAM.

Theoretically, the induced electromotive force (EF) in the magnetic field is contributed by many intrinsic properties, for example, the ratio of two coils (stator, rotor) loops, the strength of magnetic flux, the time rate of flux, and so on. In the high flux strength of magnetic filed, the magnitude of corresponding attractive force between rotor and stator is strictly high and related to the above factors. And it is referred to this as “magnetic reluctance (MR)”.

We install a generator embedded into the dynamic-adaptive-damping attenuant mechanisms on this system dedicated to the braking. After the magnetization process in the magnetic coil, which for the AC generator is the wired coil on the rotor, then the magnetic reluctance force is so-called “braking effect”.

For the purpose of braking, this generator is driven by the propeller on the vehicle. If the car is travelling at high speed, that means the angular velocity of the propeller is large. At this moment, the magnetic flux rate also changes positively proportion to the angular velocity of the propeller. When a rotor magnetic field coil is provided with high flux density, it takes slight rotation or a little change in flux to produce a higher corresponding back induced electromotive force. That is, under other conditions being constantly fixed, the strength of back electromotive force changes in proportion to the rate of the flux change. Any circuit and component could be destroyed by this higher back electromotive force or huge voltage shock. Consequently, the primary limitation in the electrical-magnetic braking is the highly back induced electromotive force which results in the system to be broken down. Up to now, the most common usage is to incorporate with the voltage regulator. The magnitude of the current in magnetic coil has been repressed so as to avoid the disaster of shock. Hence, the magnetic reluctance force is also decreased which stands for the braking force is dropped off. In the sequel, the braking force faded out as for no more work.

Moreover, for another way, if using the stronger damping diodes as the damper for consuming this back electromotive force, here the temperature increases very quickly and we have to absorb the heat effectively. For removing the heat energy, the additional air or water cooling components have to be added into the braking system. In practice, there are many physical constraints to be addressed, for instance, the space to add the cooler in, the safety, and so on. Obviously, it has been brought the reasons out to use the magnetic reluctance force as the braking force is difficult to produce the actual reliable braking effect. The effective and realtime braking task is more severely troublesome. Eventually, for example, the SCANIA bus at Taiwan, can work only just 3-5 seconds in the lower speed and very hard to keep working continuously. For the high speed case, it completely fails to carry out the braking task. After all, it has been brought the reason out why we are using the DADAM's magnetic reluctance force to produce the concrete and reliable braking effect.

Based on the concept of the energy transformation, the high speed vehicle is regarded as the vehicle with large kinetic energy. The braking that means to block the vehicle motion and the kinetic energy is transformed into the thermo or electrical energy. We need not only design an electrical magnetic device interconnected with braking system which can be protected from the shock but also allow enough high strength magnetic flux to keep this device to generate the magnetic reluctance force. As the braking occurred, we have to enlarge the current passed through the magnetic coil to generate larger magnetic reluctance force, and then induce more powerful braking force. To prevent the shock, the high back electromotive force (e.m.f) could be attenuated by somehow mechanisms internally. In common, these mechanisms are called as the dynamic damper. The alternative current generated passes through the dynamic damper. The virtual power is built in the dynamic damper and the temperature constantly increases according to the impedance change. In other words, the energy consumption is contributed by the virtual power not real power. When the temperature gets higher, the impedance is produced synchronously so that the impedance variation is related to the heat dynamically but not enough to burn down any system component. Alternatively, the impedance change affecting the dynamic buffer size follows the temperature change.

Meanwhile, comparing the magnitude of impedance with the other external connected device, for instance, the electrical charging system, the magnitude of the internal impedance is smaller than the others. The shock is going to pass the shortcut of the electrical part of the DADAM. That is, the shock is isolated and allocated at the DADAM internally. After the shock is applied, the impedance plays a role of the fast switch for attenuating the shock. As the temperature increases, the heat source and the switching frequency (fast turning on and off) of this switch change simultaneously. In circuit of RLC, the frequency is a function of the magnitudes of inductor L, the capacitor C, and resistor R. If frequency is a variable parameter in this circuit, the value of the impedance is no longer a constant value. Totally speaking, the impedance of the system is a function of the temperature variation.

Theoretically, the notations are defined as FIG. 1 and referred to the book of contact mechanics [K. L. Johnson; Contact Mechanics, Cambridge University Press., 1987], the effective Young's module E* is defined as

$$\frac{1}{{E}^{*}} = \frac{1 - {v}_{1}^{2}}{{E}_{1}} + \frac{1 - {v}_{2}^{2}}{{E}_{2}} \qquad ( 1 )$$

Also, the another parameter kₘ which is called mean curvature and defined as

$${k}_{m} = \frac{1}{2} ( \frac{1}{{R}^{′}} + \frac{1}{{R}^{″}} ) = \frac{1}{2} ( \frac{1}{{R}_{1}} + \frac{1}{{R}_{2}} ) \qquad ( 2 )$$

The contact size is related to the mean contact pressure Pₘ and mean curvature kₘ as the following

$$\begin{matrix}α ∝ {[ \frac{{p}_{m} ( \frac{1}{{E}_{1}} + \frac{1}{{E}_{2}} )}{( \frac{1}{{R}_{1}} + \frac{1}{{R}_{2}} )} ]}^{\frac{1}{3}} = {[ \frac{{p}_{m} ( \frac{1}{{E}_{1}} + \frac{1}{{E}_{2}} )}{2 {k}_{m}} ]}^{\frac{1}{3}} \\ or \\ {P}_{m} ∝ {[ \frac{{p ( \frac{1}{{R}_{1}} + \frac{1}{{R}_{2}} )}^{2}}{{( \frac{1}{{E}_{1}} + \frac{1}{{E}_{2}} )}^{2}} ]}^{\frac{1}{3}} = {[ \frac{{p ( 2 {k}_{m} )}^{2}}{{( \frac{1}{{E}_{1}} + \frac{1}{{E}_{2}} )}^{2}} ]}^{\frac{1}{3}}\end{matrix} \qquad ( 3 )$$

Based on the Hertz's solution for the point contact, we conclude that the following properties:

1. Contact size: a

$$a = {( \frac{3 PR}{4 {E}^{*}} )}^{\frac{1}{3}} \qquad ( 4 )$$

2. Separation: δ

$$δ = \frac{{a}^{2}}{R} = {( \frac{9 {P}^{2}}{16 {R ( {E}^{*} )}^{2}} )}^{\frac{1}{3}} \qquad ( 5 )$$

3. Maximized normal stress: p₀

$${p}_{0} = \frac{3 P}{2 π {a}^{2}} = {( \frac{6 {P ( {E}^{*} )}^{2}}{{π}^{3} {R}^{2}} )}^{\frac{1}{3}} \qquad ( 6 )$$

4. Maximized shear stress: =0.57a

$${τ}_{max} = 0.31 {p}_{0} = 0.47 \frac{P}{π {a}^{2}} = \frac{0.47 {P}^{\frac{1}{3}}}{π} {( \frac{4 {E}^{*}}{3 R} )}^{\frac{2}{3}} \qquad ( 7 )$$

where P is the applied total normal force, R is equal to

$$\frac{1}{{k}_{m}}$$

5. For the tangential contact case, the β is defined as

$$β = \frac{1}{2} [ ( \frac{1 - 2 {v}_{1}}{{G}_{1}} ) - ( \frac{1 - 2 {v}_{2}}{{G}_{2}} ) ] / [ ( \frac{1 - {v}_{1}}{{G}_{1}} ) + ( \frac{1 - {v}_{2}}{{G}_{2}} ) \qquad ( 8 )$$

Furthermore, the absolute value of is almost less than 0.25, this constant is strictly related to the coefficient of friction. Referred to (1), the coefficient of friction is always smaller than

$$\frac{β}{5} ,$$

i.e.

$$0 \text{<} \leq \frac{β}{5} \qquad ( 9 )$$

If the material properties (tyres, road) G₁, G₂, v₁, v₂ and weight of the vehicle are fixed, the friction force fᵣ at the contact patch then never changes.

$${f}_{r} = P \leq \frac{β P}{5} \qquad ( 10 )$$

To see more details of the dynamic behaviors of braking system, refer to the thesis [2]. By this way, see the equations (4), (5), (6) and (7), the contact size varied with magnitude of normal force is also a constant value. That is, the braking force is almost constant value except from the numbers of tires and the weight of the vehicle increased. From the viewpoint of tribology (wear, friction and lubrication), there exists a quite obvious limitation that the braking force is not enough to block the high speed motion in the vehicle systems.

We need to perform some different kinds of design for eliminating the side effects of this bottleneck, i.e., elevating the safety of high speed vehicle and providing the basic implementation issues of the energy recycling on braking. We are firstly claimed that the shock should be isolated and attenuated completely. In a sequel, the sharpness of kinetic energy relaxation process should not be appeared anymore. And the superabundant energy is buffered and located at the dynamic buffer zone. After the self-attenuation process in the generator, the peaceable energy can be extracted out and re-entered into the energy storage system, for example, the electrical charging system. The most important point is that smoothly and continuously working for each braking cycle is carried out. We secondly concluded that the dynamic buffer effect contributing to the energy recycling on braking is straightly worked. In the vehicle braking system, the variation of load is extremely different. If the mechanical-electrical system without any buffer or with fixed buffer zone, it is easy to be destroyed by the limiting load occurred. Again we should be emphasized on the buffer size to be regulated automatically and dynamically. It is called the adaptive buffer zone. For the time being, we can do a summary for the DADAM as the following properties:
1. Highly tolerant voltage and current.
2. Dynamic damping effect.
3. Wide bandwidth of frequency response.
4. Virtual load locating.
5. Adaptive impedance regulation.
6. No strict gradient of temperature.
7. Low cost.
8. Dynamic buffer size generating.
9. No extraneous power consumption.
10. Self attenuation without second shock generation.

### BRIEF DESCRIPTION OF THE DRAWINGS

FIG. 1 is a schematic view showing the notation definition;

FIG. 2 is a schematic view for the internal equivalent circuit of electrical part of the DADAM;

FIG. 3 is a schematic view of a generic AC generator;

FIG. 4 is a schematic view of the principle of the DADAM embedded into the generator;

FIG. 5 is a schematic view of the complete electric-magnetic auxiliary braking and energy recycling system;

FIG. 6 is a schematic view showing the magnetic coil in the DADAM's AC generator;

FIG. 7 is a schematic view showing the internal (Zi) and external (Zₒᵤₜ) impedances distribution; and

FIG. 8 is a schematic view showing the shock V1, V2, and V3 occurred in the DADAM's AC generator.

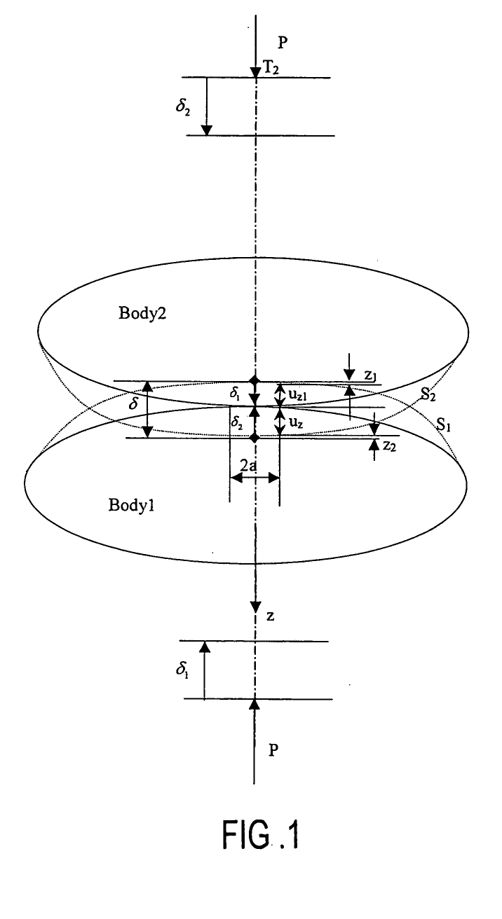

### DETAILED DESCRIPTION OF THE PREFERRED EMBODIMENT

2. Implementation

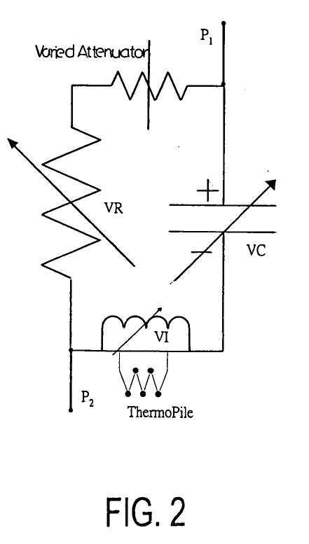

As shown in FIG. 2, the structure of electrical part of DADAM can be simply sketched, where p₁ and p₂ are the procedure to input pins, and the component thermopile plays a role of the positive (negative) thermo effect.

Of course, the magnitudes of the varied resistor (VR), varied capacitor (VC), varied inductance (VI), varied attenuator (VA) are dependent on the loads and the impedance of the other connected devices respectively.

And the thermopile plays a nominal role of fast switch and follows the temperature when it changes. For the positive type, as the shock comes, the temperature is getting high; the correspondence impedance becomes a proportionately large value. After the shock is removed, the temperature is going down; the impedance also returns to the nominal area and waits for the next cycle to come. In the transition process, how fast the switch works on is dependent on the natural frequency of material, i.e., what kind of material made. The bandwidth of frequency response, under 10.0 GHz, is now capable of using and more strictly related to the realistic implementation issues (for example, SiGe, GaAs, InP, . . . ). If the gradient of temperature is positive (negative), the frequency of switching should be speeded up (slowed down) and transit into some kind of equivalent state between temperature change and impedance increase (decrease). When the shock coming, the impedance (contributed from the electrical part of DADAM) has been self-tuning more and more again and adaptively going back to the temperature-impedance steadily state. The VR, VC, VI, VA are dynamically determined from the magnitude of shock input and finally produced an equivalent state internally.

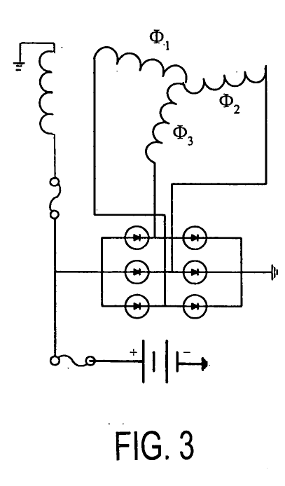

The original three-phase AC generator is as shown in FIG. 3. The difference of phase angles between ₁ and ₂, ₂ and ₃ or ₃ and ₁ is ⅔.

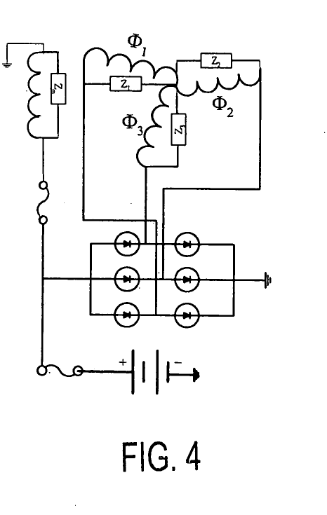

When DADAM has been embedded into 3-phase AC generator, the system is modified as shown in FIG. 4.

The primary difference between the original and modified AC generators G has been mounted on the DADAM components Z₁, Z₂ and Z₃ dynamical impedance as that shows in FIG. 4, Zₘ is the avoidance of the second high induced e.m.f. for the input of the magnetic coil damage. In the same time, they lead high induced e.m.f. into the stator (Z₁, Z₂ and Z₃) and rotor (Zₘ) and induce that self attenuation process to re-start up again and again. Take notice that the numbers of the dynamical impedances are equal to the numbers of phases of the stator. Again, the magnitude of all of dynamical impedance is dependant on the real problems requirement and determined dynamically.

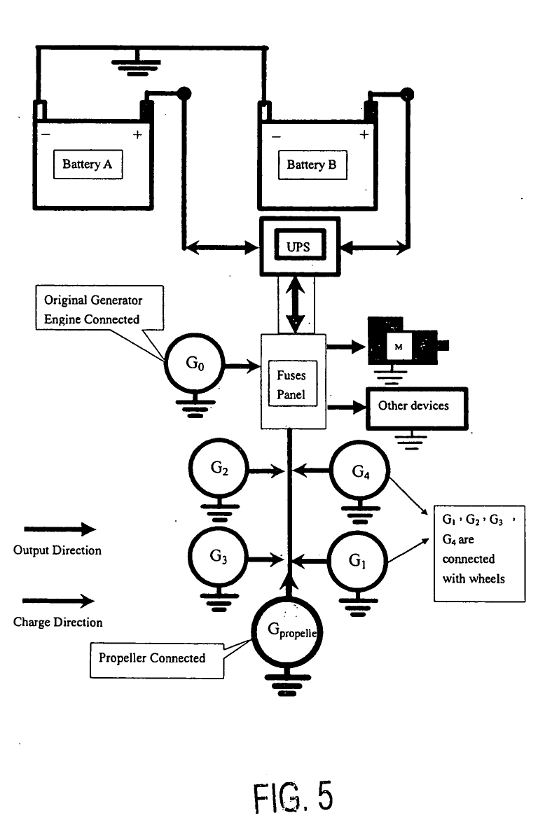

Finally, we are presented the complete energy recycling and electric-magnetic auxiliary braking system as shown in FIG. 5.

In FIG. 5, we have add six generators G₀, G₁, G₂, G₃, G₄ and G₅ to be embedded into the DADAM, where G₀ is driven by power source (engine), G₁, G₂, G₃, G₄ are driven by the four wheels (Front-Right, Front-left, Back-Right, Back-Left sides respectively. Without loss of direction on braking concentrating, G₅ is the primary DADAM type generator driven by the propeller for the auxiliary braking and energy recycling on braking. We are able to increase the numbers of generator for the heavy load case.

In order to avoid over charging problem, incorporating the circuit of the UPS (Un-interruptible Power Supply) in this area can help us to switch which battery (A or B) to store recycling electrical energy in realtime.

The Principle of the DADAM

The working principles of the DADAM are concluded as the followings:

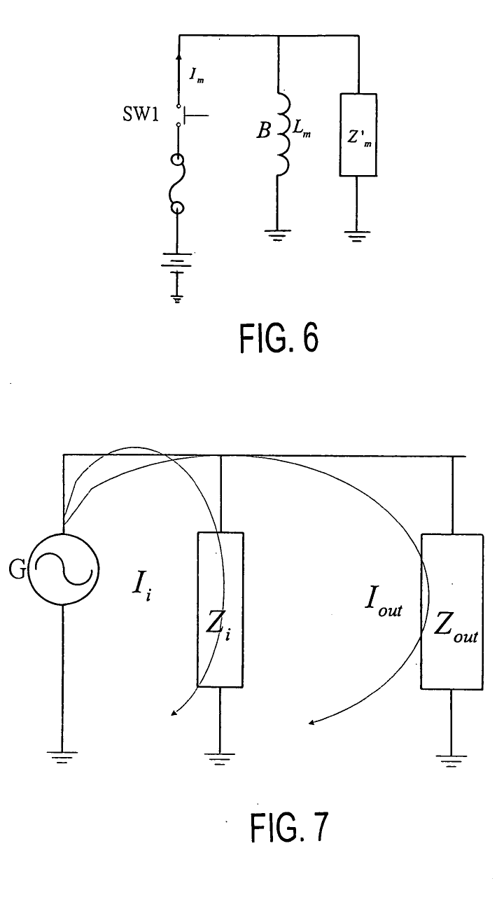

1. as shown in FIG. 6, SW1 on, the current Im passes through the magnetic coil with inducant Lm and then the flux B built up. The strength of the flux is proportional to the product of the current and loops of the coil,
B∝IₘNₘ
the value of the impedance is Zm and Z′m simultaneously. Also, as shown in FIG. 7, the DADAM's electrical-magnetic braking system now is working on. When enlarging the input current Im, the braking effect is enhanced. To this end, the impedance Z₁ is always slightly smaller than the outer impedance Zₒᵤₜ so that Iₒᵤₜ is smaller than the current Iᵢ. Because the electrical parts of the DADAM's braking system are the temperature dependent, the current passed through Z₁, Z₂, Z₃ and the switching frequency is moving to high. Comparing the internal impedance Zᵢ with Zₒᵤₜ, Zᵢ is totally smaller than the Zₒᵤₜ. Here the Zᵢ is a fast switch. When this switch is on, Zᵢ is a shortcut for the shock. On the contrary, when this switch is off, the shock is going to fan out. At the same time, the switch changes the status on, the shortcut effect is triggered on. The status switching is working again and again. For the fast on and off status switching, the shock is firmly isolated and stays at the Zᵢ.

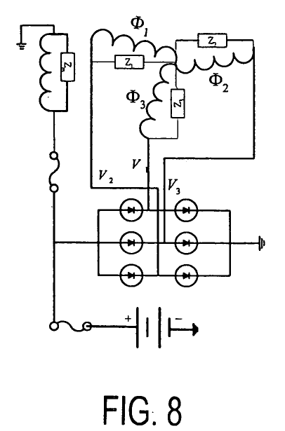

2. At the shock V₁, V₂, V₃ occurred, as shown in FIG. 8, the high temperature built up and the gradient of temperature is fed into the stator coil of the DADAM's AC generator and then determining the value of the impedance and the switch frequency. At the kinetic energy transferred to the electrical energy process, the least thermo energy is converted to the on and off actions and regulating the magnitude of the impedance. The superabundant energy is cycling on the DADAM's electrical-magnetic braking system only, no any energy loss. This is a dynamic damper effect. The shock is attenuated by this dynamic damper.

3. If designing the value of Zᵢ is always dynamically smaller than the Zₒᵤₜ, firstly the shock is directly across the Zᵢ. at the original state (0-state), the current Iᵢ⁰ is firstly passed through and the high temperature field is then built, the magnitude of impedance Zᵢ becomes a large valve and the state of Zᵢ has changed to 1-state (high temperature status), the current Iᵢ¹ becomes a smaller value than Iᵢ⁰. In fact, once the electrical energy is led out to the charging system immediately and the temperature is getting down. As the temperature gradient being a negative value, the status (1-state) right now changes to the original status (0-state), without any current across Zₒᵤₜ. The state changes between the 0-state and 1-state are no stop until the shock removed. We denote these states transition with a very wide operating frequency band. After all, the shock produced on braking is recycled.

4. From the shock isolation, attenuation and finally recycling to the electrical charging system, all of them are dynamic and adaptive self-balancing processes. It is truly without any digital or analog controller add-on.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1-2. (canceled)

3. A dynamic adaptive damping attenuant mechanism (DADAM) electrical magnetic braking system comprising an AC generator and multiple interconnected electronic fast switches, wherein the multiple electronic fast switches, which are proportional to temperature variation and a function of switching frequencies to regulate impedance adaptively and are embedded into the AC generator to allow the ac generator to be called “DADAM AC generator” to produce an electrical-magnetic braking force after a magnetizing process in the DADAM AC generator.

4. The dynamic adaptive damping attenuant mechanism (DADAM) electrical magnetic braking system as claimed in claim 3, further comprising means for changing the impedance with the temperature, isolating, damping and attenuating voltage shock in the DADAM AC generator and dynamically holding the surplus energy in the DADAM AC generator under braking.

5. The dynamic adaptive damping attenuant mechanism (DADAM) electrical magnetic braking system as claimed in claim 3, wherein an electrical magnetic anti-skid braking is induced by the operating switching frequencies of the electronic fast switches.

6. The dynamic adaptive damping attenuant mechanism (DADAM) electrical magnetic braking system as claimed in claim 4, wherein an electrical magnetic anti-skid braking is induced by the operating switching frequencies of the electronic fast switches.

7. The dynamic adaptive damping attenuant mechanism (DADAM) electrical magnetic braking system as claimed in claim 3, wherein the means for changing the impedance with the temperature, isolating, damping and attenuating voltage shock in the AC generator is able to recycle the surplus energy in the DADAM AC generator into an electrical charging subsystem.

8. The dynamic adaptive damping attenuant mechanism (DADAM) electrical magnetic braking system as claimed in claim 4, wherein the means for changing the impedance with the temperature, isolating, DAMPING and attenuating voltage shock in the AC generator is able to recycle the surplus energy in the DADAM AC generator into an electrical charging subsystem.

9. The dynamic adaptive damping attenuant mechanism (DADAM) electrical magnetic braking system as claimed in claim 7, wherein two pins of each of the electronic fast switches, which are interconnected with the varied resistor (VR), varied capacitor (VC), varied inductance (VI), varied attenuator (VA) and thermopile, are interconnected with two ends of each phase of the stator and rotor coils in the DADAM AC generator, and are driven by a propeller in a vehicle, in which two output pins are connected with the electrical charging subsystem.

10. The dynamic adaptive damping attenuant mechanism (DADAM) electrical magnetic braking system as claimed in claim 8, wherein two pins of each of the electronic fast switches, which are interconnected with of the varied resistor (VR), varied capacitor (VC), varied inductance (VI), varied attenuator (VA) and thermopile, are interconnected with two ends of each phase of the stator and rotor coils in the DADAM AC generator and are driven by a propeller in a vehicle, in which two output pins are connected with the electrical charging subsystem.
